(19) United States
(12) Patent Application Publication
(10) Pub. No.: US 2020/0004030 A1
(43) Pub. Date: Jan. 2, 2020

(54) PROJECTION DISPLAY APPARATUS

(71) Applicant: CANON KABUSHIKI KAISHA, Tokyo (JP)

(72) Inventor: Takehiro Koyama, Utsunomiya-shi (JP)

(21) Appl. No.: 16/447,836

(22) Filed: Jun. 20, 2019

(30) Foreign Application Priority Data
Jun. 29, 2018 (JP) 2018-125522

(51) Int. Cl. G02B 27/09; G02B 27/10; G02F 1/1335; H04N 9/31; G02B 5/30

(52) U.S. Cl. CPC G02B 27/0972; G02B 27/1006; G02B 5/3025; H04N 9/31; G02F 1/133553

(57) ABSTRACT

An image display apparatus includes a color combining prism configured to combine a plurality of image light components from a plurality of image display elements, a plurality of polarization separating elements disposed on light paths of the plurality of image light components, a plurality of light transmitting members fixed to a plurality of entrance surfaces through which the plurality of image light components enters the color combining prism, and a supporting member configured to support a pair of a light transmitting member and a polarization separating element corresponding to each other out of the plurality of light transmitting members and the plurality of polarization separating elements, wherein the supporting member is disposed on a side surface of the light transmitting member.

### BACKGROUND

### Field of the Disclosure

The present disclosure generally relates to projection display and, more particularly, a projection display apparatus and to downsizing and improvement of image quality of a projection display apparatus including an optical system using a polarizing plate disposed in a closed space.

### Description of the Related Art

In recent years, the number of pixels of liquid crystal projectors has been increased, and in particular, in simulation use, a projector equipped with an optical system that places emphasis on high contrast mounted has become useful. In an optical system using a reflective polarizing plate having a wire grid structure, the glass member disposed on a light path is replaced with air as compared with the configuration using a conventional polarization beam splitter. This configuration may reduce deterioration of contrast due to photoelasticity generated in an optical component in principle. Japanese Patent Laid-Open No. 2007-108735 discloses a technique of supporting wire grid Polarizing Beam Splitters (PBSs) and reflective liquid crystal panels by disposing supporting members that support the wire grid PBSs and the reflective liquid crystal panels on light paths of three color light components of Red (R), Green (G), and Blue (B), and adhesively connecting the three units to entrance surfaces of the prism.

In an optical system using a reflective polarizing plate such as a wire grid PBS, a reflective wire grid PBS is disposed between conventional prism and panel. Thus, an air gap increases. Therefore, the distance between the prism and the reflective liquid crystal panel (back focus) tends to be long. In the related art, units each including a reflective polarizing plate, a liquid crystal panel, and a mechanical supporting member for supporting them disposed on a light path of corresponding one of three color light components are fixed to the entrance surface of the prism. When the units are fixed to the entrance surfaces of the prism as described above, the units and the prism are often adhesively connected. When such adhesion is performed, the prism and the prism unit become large in order to secure the adhesive area, which is disadvantageous.

### SUMMARY

In order to address the above-described disadvantages, according to one or more aspects of the present disclosure, an image display apparatus includes: a plurality of image display elements corresponding to a plurality of color light components; a color combining prism configured to combine a plurality of image light components from the plurality of image display elements; a plurality of polarization separating elements each disposed on corresponding one of a plurality of light paths on which the plurality of image light components from the plurality of image display elements travels to the color combining prism; a plurality of light transmitting members fixed to a plurality of entrance surfaces through which the plurality of image light components enters the color combining prism; and a supporting member configured to support a pair of a light transmitting member and a polarization separating element corresponding to each other out of the plurality of light transmitting members and the plurality of polarization separating elements, wherein surfaces of the color combining prism to which the light transmitting members are disposed are larger than the surfaces of the light transmitting members disposed on the color combining prism, and wherein the supporting member is disposed on a side surface of the light transmitting member.

Further features of the present disclosure will become apparent from the following description of exemplary embodiments (with reference to the attached drawings).

### BRIEF DESCRIPTION OF THE DRAWINGS

FIG. 1 is a top view of a projection display apparatus according to a first exemplary embodiment.

FIG. 2 is a side view of the projection display apparatus according to the first exemplary embodiment.

FIG. 3 is a view of a color combining optical system according to the first exemplary embodiment as viewed from the lower side.

FIG. 4 is a view of the color combining optical system according to the first exemplary embodiment viewed from the upper side.

FIG. 5 is a view of the color combining optical system according to the first exemplary embodiment as viewed from the lower side.

FIG. 6 is a side view of the projection display apparatus according to the first exemplary embodiment.

FIG. 7 is a side view of a projection display apparatus according to a second exemplary embodiment.

### DESCRIPTION OF THE EMBODIMENTS

Hereinafter, various exemplary embodiments, features, and aspects of the present disclosure will be described in detail with reference to the attached drawings.

### First Exemplary Embodiment

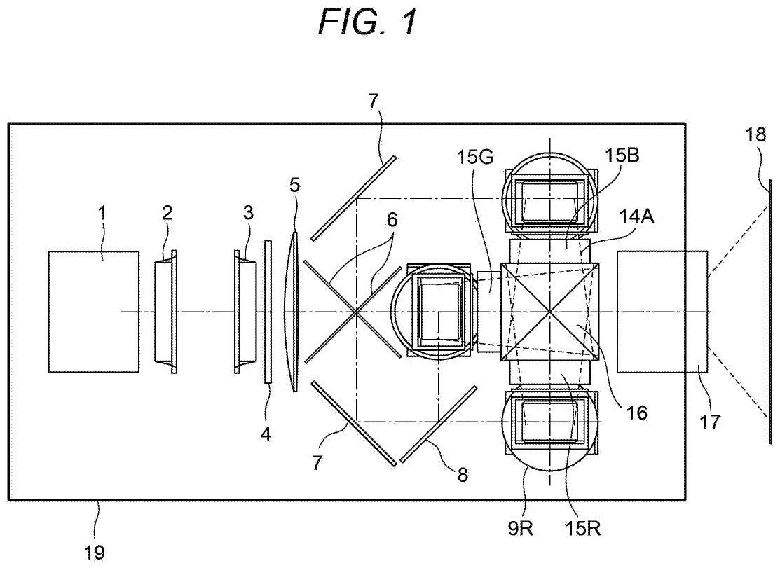

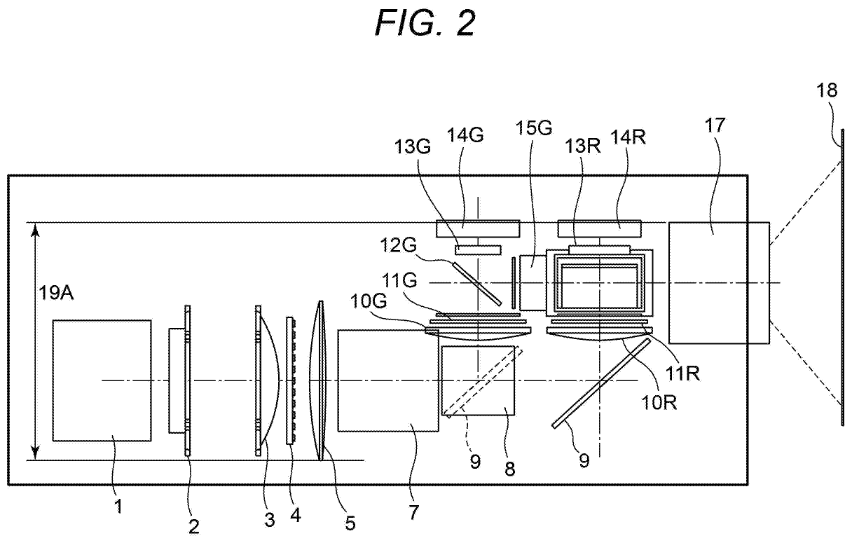

FIG. 1 illustrates a top view of a projection display apparatus (image display apparatus or projector), and FIG. 2 illustrates a side view of the projection display apparatus. The projection display apparatus of the present exemplary embodiment includes a plurality of reflective liquid crystal panels (reflective image display elements or reflective liquid crystal panels) corresponding to a plurality of color light components, a color combining prism that combines color light components (image light components) from the reflective liquid crystal panels, and a reflective polarizing plate that analyzes the image light component from each panel.

Light that has exited from a light source 1 (lamp light source or laser light source) is split into a plurality of light beams by passing the light through a first fly-eye lens (fly-eye lens A) 2 and a second fly-eye lens (fly-eye lens B) 3 (a state where a pupil is divided is made). The plurality of light beams obtained by the split exits from a polarization conversion element 4, which aligns the polarization directions of the light beams, and then is condensed by a condenser lens 5. The light obtained by the condensation is split into two color light components depending on the wavelengths by color splitting dichroic mirrors 6. In the present exemplary embodiment, out of the two color light components, one color light component is a blue light component and the other color light component is a color light component obtained by mixture of a red light component and a green light component, but the present disclosure is not limited to these color light components.

The two color light components obtained by the split depending on their wavelengths are redirected by reflecting mirrors 7. Thereafter, one color light component (the color light component obtained by mixture of a red light component and a green light component) is further split into two color light components (a green light component and a red light component) by a dichroic mirror 8. The light that has passed through the dichroic mirror 8 is redirected upward (upward in the product height direction) by an upward reflecting mirror 9 (a mirror 9R on the red light path, and similarly, mirrors 9G and 9B respectively on the green light path and the blue light path). The upward direction may be defined as a direction perpendicular to the plane formed by the light path of an entering light beam that enters the dichroic mirrors 6 traveling on the optical axis of the above-described condenser lens 5 and the light path of two exit light beams obtained by the split by the dichroic mirrors 6.

The red light component, the green light component, and the blue light component which have been redirected upward as described above enter condenser lenses 10R, 10G, and 10B respectively, and then enter reflective liquid crystal panels 14R, 14B, and 14G respectively in a telecentric state or in a state close to it. These red light, green light and blue light components are transmitted through the entrance side polarizing plates 11R, 11G, and 11B, reflective polarizing plates (polarization beam splitters) 12R, 12G, and 12B, and phase compensation plates 13R, 13G, and 13B for contrast adjustment before entering the reflective liquid crystal panels. Here, the symbols R, G, and B respectively indicate members disposed on the red light path, green light path, and blue light path respectively, and not all of the members are shown. For example, the condenser lens 10R is a condenser lens disposed on the red light path of red light. In addition, it is desirable that the reflective polarizing plates each be disposed to have a polarization separating surface inclined by about 45 degrees with respect to the traveling direction of the light beam of the corresponding color light component, and to have an entrance surface and an emission surface similarly inclined by 45 degrees. In addition, it is desirable that this reflective polarizing plate be a wire grid polarization plate (polarization beam splitter). However, the reflective polarizing plate may be a reflective polarization plate (polarization beam splitter) including a dielectric multilayer film.

The light components that have passed through phase compensation plates 13 are reflected and modulated by the reflective liquid crystal panels (reflective image display elements) 14R, 14B and 14G (the polarization direction is changed for each pixel) to be converted to image light components having image information. Each of the color light components reflected by the reflective liquid crystal panels 14 passes through corresponding one of the phase compensation plates 13, and part (or whole) of the color light component is bent by 90 degrees by the reflective polarizing plate 12, and (part or whole of) the remaining color light is transmitted through the reflective polarizing plate 12. Each of the color light components reflected by the reflective polarizing plates 12 enters one of cover glasses 15R, 15G, and 15B corresponding to the color light component. The cover glasses 15R, 15G, and 15B are disposed on (adhered to) the entrance surfaces of a prism (cross prism) 16. The RGB (red, green, blue) light components having been transmitted through the cover glasses 15 are combined by the color combining prism 16 in the same plane as the horizontal direction of the product (in the plane described above) and projected on a screen 18 by a projection lens (projection optical system) 17. The optical system described above is accommodated in the main body of a projection display apparatus 19.

Here, the color combining prism 16 has a function of combining red, green and blue image light components and guiding the obtained light to the projection lens 17. The color combination plane (the plane illustrated in FIG. 1) formed by the center light beam traveling through the center of each of the color light components (a light beam emitted perpendicularly from the center of the image on the panel or a light beam traveling on the optical axis of the projection lens after the color combination) and the light path of the light beam obtained by the combination is the lateral plane of the apparatus. That is, the direction perpendicular to the color combination plane (the direction perpendicular to the paper surface of FIG. 1 or the up and down direction of FIG. 2) matches the height direction (thickness direction) of the apparatus.

Next, a method of supporting the reflective polarizing plates 12 (wire grid (WG) polarizing plates) described in the present exemplary embodiment and a method of supporting the reflective liquid crystal panels will be described.

In FIG. 1, a light beam 14A is the outermost light beam among the light beams that have exited from the reflective liquid crystal panel. As can be seen from the light path of the light beam 14A, the light beams (image light) that have exited from the reflective liquid crystal panel gradually increase the effective light flux diameter (effective diameter) as the light beams approach the projection lens from the reflective liquid crystal panel. Also in FIG. 1, as the light that has been transmitted through the cover glass 15 enters the color combining prism 16, the effective light flux diameter gradually increases. As a result, the cover glass 15 can be configured such that the outer diameter size in the direction perpendicular to the optical axis is smaller than that of the color combining prism 16 (can be made smaller in two directions that are perpendicular to each other in the plane perpendicular to the light path of light traveling on the optical axis). Therefore, the area of the cover glass when viewed from the light traveling direction can be made smaller than the area of the color combining prism. In other words, the surface of the cover glass adhered to the color combining prism can be made smaller than the surface of the color combining prism to which the cover glass is adhered. By adhering the cover glass 15 to the color combining prism as described above, the outer shape of the color combining prism 16 can be downsized without changing the light path length.

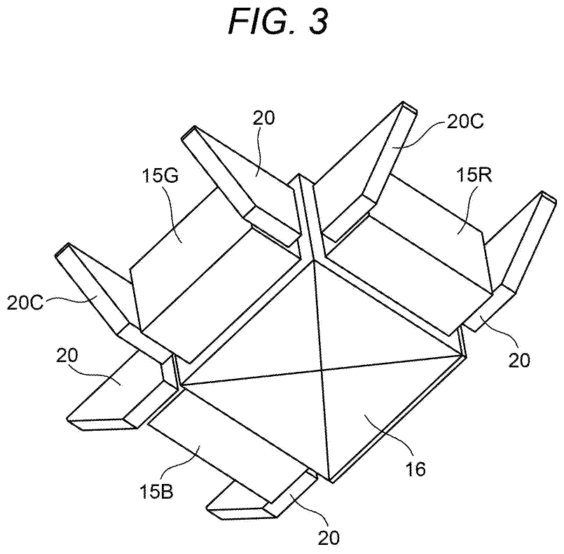

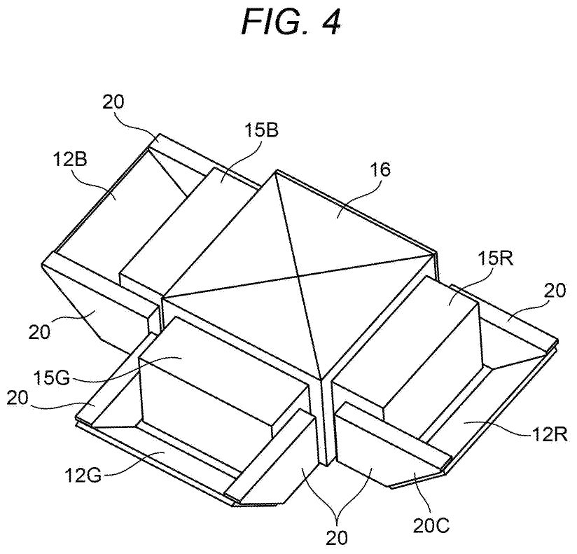

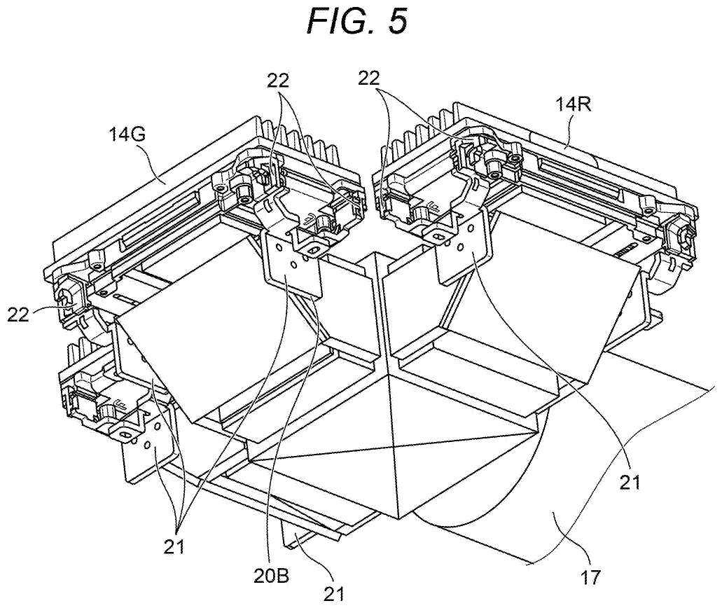

In this exemplary embodiment, while utilizing this configuration, as illustrated in FIG. 3, the unit can be downsized by adhering supporting members (fixing member, supporting and fixing member) 20 to the side surfaces of the cover glasses 15. In addition, as illustrated in FIG. 4, each of the supporting members 20 has an attachment surface (slope surface portion 20C) to which one of the reflective polarizing plates 12 is attached. Further, as illustrated in FIG. 5, the supporting member 20 includes an adhesive surface 20B, to which a panel supporting member 21 supporting one of the reflective liquid crystal panels 14 is attached. The liquid crystal panels 14R, 14G, and 14B are fixed (adhered) to the panel supporting member 21 by spacer members 22. As described above, each pair of the supporting members 20 has a function of supporting a light transmitting member in the form of one of the plurality of cover glasses and corresponding polarization separating element in the form of one of the plurality of reflective polarizing plates as a pair (fixing the relative position and orientation).

Because of this configuration, the outer shapes of the color combining prism 16 and the cover glasses 15 are determined by the size of the range through which light beams pass. The outer shapes of the color combining prism 16 and the cover glasses 15 need not be made larger to provide surfaces for fixing the reflective liquid crystal panels 14 and the reflective polarizing plates 12.

Further, the supporting members 20 are disposed in the dead space inside the optical system. Thus, there is no factor that increases the size of the prism unit as a whole. Therefore, it is possible to minimize a size 19A in the height direction of the projection display apparatus illustrated at least in FIG. 2.

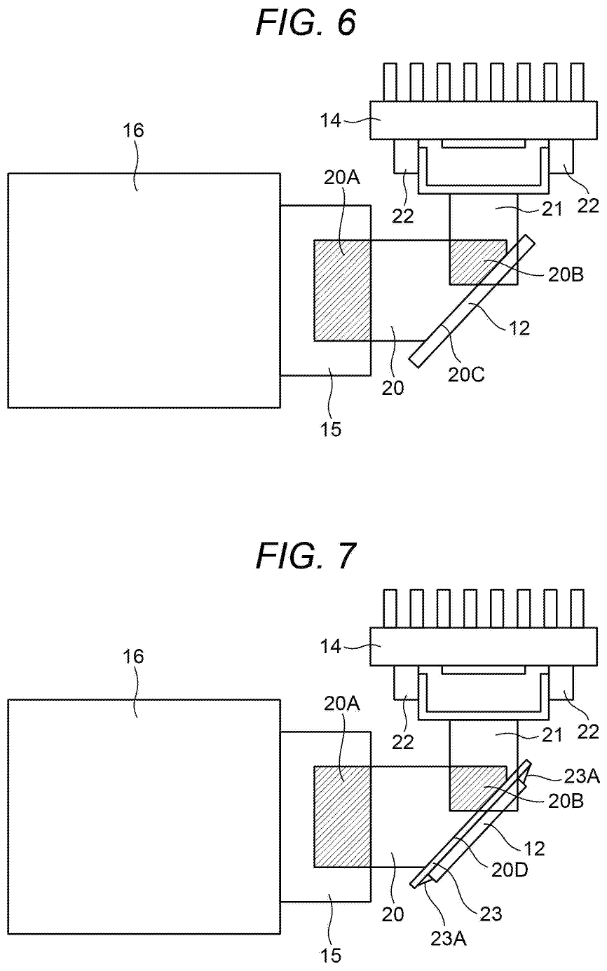

FIG. 6 is a side view illustrating a state in which each of the components is fixed to the cover glass 15 (a light transmitting member, a transparent member, and a glass member disposed on the light path between the color combining prism and the reflective polarizing plate). Here, the cover glass 15 may be any transparent member (light transmitting member) that is fixed (adhered) to the color combining prism 16 and transmits visible light. The cover glass 15 is adhesively fixed to the supporting members 20 (desirably using an ultraviolet (UV) adhesive or the like), and the adhesive surfaces are provided on the side surfaces (an adhesive surface 20A in FIG. 7) of the cover glass 15. Here, the side surfaces of the cover glass are the surfaces other than the surface through which one of the color light components of image light (or illumination light of one color) enters or the surface through which the light exits (one of the surfaces faces the prism and the other surface faces the reflective polarizing plate).

In this manner, the supporting members 20 supporting the reflective polarizing plate (fixed to the reflective polarizing plate) and the cover glass 15 are fixed (adhered) to the side surfaces of the cover glass 15. Therefore, the setting of the adhesive area can be set freely to some extent corresponding to a desired adhesive strength without changing the size of the optical glasses such as the color combining prism 16 and the cover glass 15. Similarly, the adhesive surface 20B adhered with the panel supporting member (fixing member or panel polarizing plate fixing member) 21 and an adhesive surface 2D of the reflective polarizing plate 12 can be freely set without changing the size of the optical glasses such as the color combining prism 16 and the cover glass 15.

The panel supporting members 21 are configured to support the reflective liquid crystal panels 14R, 14B, and 14G. Here, the panel supporting members 21 are fixed (adhered) to the color combining prism 16 via the above-described spacer members, and in this exemplary embodiment, the panel supporting members 21 are adhesively fixed by a UV adhesive or the like.

The material of the supporting member 20 is preferably a material having a small coefficient of linear expansion, such as glass, ceramic, iron-based metal, or a mixture of two or more thereof. By using a material having a small linear expansion coefficient, even when the projection display apparatus is turned on and the temperature at each place is changed (rises), the amount of change of various parameters due to the temperature change can be reduced. For example, when the temperature of the supporting member 20 rises, the distance from the reflective liquid crystal panel 14 to the reflective polarizing plate 12 changes, but the amount of change can also be reduced. Thus, it is possible to reduce deterioration of the image quality due to deviation of the relative position between the reflective polarizing plates 12 and each of the reflective liquid crystal panels 14R, 14B and 14G disposed on the light path of corresponding one color light component when the temperature change occurs in the projection display apparatus.

In particular, when glass is used as the material of the supporting member 20 (and the panel supporting member 21), the accuracy of the processing surface can be increased more easily than that when a metal component is used. Thus, the thickness variation of the adhesive due to the surface accuracy of the adhesive surface can be reduced. Even if an external load or a temperature load is applied to each member after the adhesion, the positional deviation of each component due to softening of the adhesive can be reduced. In addition, since the linear expansion coefficient can be set closer to that of the cover glass 15 and the reflective polarizing plate (the substrate is made of a glass member), the strain applied to the adhesive portion when the temperature changes can be reduced. This can reduce positional deviation due to fine peeling of the adhesive.

In the first exemplary embodiment, the prism to which the cover glasses are adhered is the color combining prism 16 that combines the image light components of three colors modulated by the reflective liquid crystal panels, but other prisms can be used. Specifically, the prism to which the cover glasses are adhered may be a color splitting prism that splits the light (illumination light) from the light source into a plurality of color light components (a plurality of illumination light components corresponding to the colors). In that case, the order of the parts through which light travels described above is reversed. Therefore, the reflective polarizing plate is supported by the supporting members (fixing member) adhered to the side surfaces of the cover glass (light transmitting member) adhered (fixed) to the color splitting prism.

### Second Exemplary Embodiment

In the first exemplary embodiment, the configuration in which the supporting members 20 directly support the reflective polarizing plate 12 is described. However, the second exemplary embodiment discloses an example in which a supporting member 20 supports a reflective polarizing plate 12 via a holder member 23 as illustrated in FIG. 7.

First, as described above, in the second exemplary embodiment, the holder member 23 capable of adjusting the position and the inclination of a reflective polarizing plate (WG polarizer) is used. The relative position and orientation between the supporting member 20 and the reflective polarizing plate 12 are changed by moving the holder member 23 while the holder member 23 supports the reflective polarizing plate (wire grid polarizing plate, WG polarizing plate, or wire grid polarization beam splitter). This holder member is a member capable of adjusting at least one of the relative position and orientation between the reflective polarizing plate 12 and the supporting member 20 (or a cover glass 15, or a color combining prism 16). It is desirable here that the holder member can change the position and orientation of the supporting member 20 (or a cover glass 15 or a color combining prism 16) and the reflective polarizing plate 12 without changing the relative position and orientation between the supporting member 20 and the liquid crystal panel.

Here, the reflective polarizing plate 12 is fixed to the holder member 23 by an adhesive (such as a UV adhesive) 23A.

The holder member 23 has, for example, a square shape having an opening at the center (not illustrated), and is formed of a plate member having an outer diameter larger than that of the reflective polarizing plate 12. A reflective polarizing plate is attached to the holder member, and the side surfaces of the reflective polarizing plate 12 are adhered with an elastic adhesive 20D. The holder member 23 and the reflective polarizing plate 12 in a state of an integrated unit are adhered to the supporting members 20 (or to the panel supporting members 21. Because of this configuration, the reflective polarizing plate 12 does not need to have an area larger than the optical effective range in order to secure the adhesive area. The adhesive area can be determined based on the thickness of the supporting member 20 in the paper surface depth direction and the outer diameter of the holder member 23. Even if the thickness of the supporting member 20 in the paper surface depth direction is changed, the dead space in the arrangement of the optical system for each color light component is utilized. Thus, enlargement of the projection display apparatus in the height direction 19A illustrated in FIG. 2 can be avoided to provide a compact projection display apparatus.

According to the present disclosure, in the WG optical system using the reflective liquid crystal panel, the supporting members are disposed on the side surfaces of the cover glass disposed on the entrance surface of the prism. In addition, by disposing the WG polarizing plate and the liquid crystal panel to the supporting member, the size in the product thickness direction is minimized. In the present disclosure, the supporting member is formed from a material having a generally small coefficient of linear expansion, such as glass, ceramic, iron-based metal. Thus, a reflective display apparatus capable of displaying high quality images is realized.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2018-125522, filed Jun. 29, 2018, which is hereby incorporated by reference herein in its entirety.

What is claimed is:

1. An image display apparatus comprising:
a plurality of image display elements corresponding to a plurality of color light components;
a color combining prism configured to combine a plurality of image light components from the plurality of image display elements;
a plurality of polarization separating elements each disposed on corresponding one of a plurality of light paths on which the plurality of image light components from the plurality of image display elements travels to the color combining prism;
a plurality of light transmitting members fixed to a plurality of entrance surfaces through which the plurality of image light components enters the color combining prism; and
a supporting member configured to support a pair of a light transmitting member and a polarization separating element corresponding to each other out of the plurality of light transmitting members and the plurality of polarization separating elements,
wherein
surfaces of the color combining prism to which the light transmitting members are disposed are larger than the surfaces of the light transmitting members disposed on the color combining prism,
and wherein
the supporting member is disposed on a side surface of the light transmitting member.

2. The image display apparatus according to claim 1, wherein
the supporting member has a coefficient of linear expansion smaller than that of the color combining prism.

3. The image display apparatus according to claim 1, wherein
the direction perpendicular to the color combining plane where the color combining prism combines the image light components matches a height direction of the image display apparatus.

4. The image display apparatus according to claim 1, wherein
the supporting member is formed from glass, ceramic, iron-based metal, or a mixture thereof.

5. The image display apparatus according to claim 1, wherein
the supporting member includes a holder member capable of adjusting at least one of a relative position and a relative orientation between the pair of light transmitting member and polarization separating element corresponding to each other.

6. The image display apparatus according to claim 5, wherein
the holder member is capable of changing a relative position and a relative orientation between the light transmitting member and the polarization separating element without changing the relative position or the relative orientation between the light transmitting member and one of the plurality of image display elements corresponding to the light transmitting member.

7. The image display apparatus according to claim 1, wherein
the plurality of image display elements is reflective liquid crystal panels.

8. An image display apparatus comprising:
a plurality of image display elements corresponding to a plurality of color light components;
a color splitting prism configured to split light from a light source into a plurality of illumination light components that illuminate the plurality of image display elements;
a plurality of polarization separating elements each disposed on corresponding one of light paths on which the plurality of illumination light components from the light source to the plurality of image display elements;
a plurality of light transmitting members fixed to a plurality of emission surfaces through which the plurality of illumination light components exits from the color splitting prism; and
a supporting member configured to support a pair of a light transmitting member and a polarization separating element corresponding to each other out of the plurality of light transmitting members and the plurality of polarization separating elements,
wherein
surfaces of the color splitting prism to which the light transmitting members are disposed are larger than the surfaces of the light transmitting members disposed on the color splitting prism,
and wherein
the supporting member is disposed on a side surface of the light transmitting member.

9. The image display apparatus according to claim 8, wherein
the supporting member has a coefficient of linear expansion smaller than that of the color splitting prism.

10. The image display apparatus according to claim 8, wherein
the direction perpendicular to the color combining plane where the color splitting prism combines the image light components matches a height direction of the image display apparatus.

11. The image display apparatus according to claim 8, wherein
the supporting member is formed from glass, ceramic, iron-based metal, or a mixture thereof.

12. The image display apparatus according to claim 8, wherein
the supporting member includes a holder member capable of adjusting at least one of a relative position and a relative orientation between the pair of light transmitting member and polarization separating element corresponding to each other.

13. The image display apparatus according to claim 12, wherein
the holder member is capable of changing a relative position and a relative orientation between the light transmitting member and the polarization separating element without changing the relative position or the relative orientation between the light transmitting member and one of the plurality of image display elements corresponding to the light transmitting member.

14. The image display apparatus according to claim 8, wherein
the plurality of image display elements is reflective liquid crystal panels.
